(19) United States
(12) Patent Application Publication
(10) Pub. No.: US 2026/0073729 A1
(43) Pub. Date: Mar. 12, 2026

(54) DATA PROCESSING METHOD AND APPARATUS FOR VIRTUAL AVATAR, ELECTRONIC DEVICE, AND MEDIUM

(71) Applicant: BEIJING BAIDU NETCOM SCIENCE TECHNOLOGY CO., LTD., BEIJING (CN)

(72) Inventors: Zhiqiang WANG, BEIJING (CN); Baoxuan GU, BEIJING (CN); Qin QIN, BEIJING (CN)

(21) Appl. No.: 19/390,318

(22) Filed: Nov. 14, 2025

(30) Foreign Application Priority Data
Dec. 3, 2024 (CN) 202411767448.6

(51) Int. Cl. G06V 40/16; G06V 10/24; G06V 20/40

(52) U.S. Cl. CPC G06V 40/168; G06V 10/242; G06V 20/49

(57) ABSTRACT

A method includes: obtaining a target image including a face of a target object; performing facial keypoint extraction on the target image to obtain a first facial keypoint image; obtaining a first set of expression coefficients based on the first facial keypoint image and a preset set of expression bases; adjusting a corresponding expression coefficient in the first set of expression coefficients to obtain a second set of expression coefficients; obtaining a second facial keypoint image based on the second set of expression coefficients and the set of expression bases; and obtaining, based on the second facial keypoint image and the target image, a first image corresponding to the target image that has undergone a facial expression transformation.

### CROSS REFERENCE TO RELATED APPLICATION

This application claims priority to Chinese patent application No. 202411767448.6 filed on Dec. 3, 2024, the contents of which are hereby incorporated by reference in their entirety for all purposes.

### TECHNICAL FIELD

The present disclosure relates to the field of artificial intelligence, in particular to the technical fields of deep learning, image processing, and digital humans, and specifically to a data processing method and apparatus for a virtual avatar, an electronic device, a computer-readable storage medium, and a computer program product.

### BACKGROUND

Artificial intelligence is a subject on making a computer simulate some thinking processes and intelligent behaviors (such as learning, reasoning, thinking, and planning) of a human, and involves both hardware-level technologies and software-level technologies. Artificial intelligence hardware technologies generally include technologies such as sensors, dedicated artificial intelligence chips, cloud computing, distributed storage, and big data processing. Artificial intelligence software technologies mainly include the following several general directions: computer vision technologies, speech recognition technologies, natural language processing technologies, machine learning/deep learning, big data processing technologies, and knowledge graph technologies.

With the development of artificial intelligence technologies, virtual digital humans have been widely applied in the fields such as live streaming, news broadcasting, and voice assistance. A virtual digital human usually needs to be driven based on audio to be played to make actions, expressions, etc. that are synchronized with the audio, thereby obtaining a video driven by the audio. Audio-driven generation of a realistic and expressive portrait video from a single face image has a broad application prospect, covering a plurality of fields such as digital media, games, and film and television production.

### SUMMARY

The present disclosure provides a data processing method and apparatus for a virtual avatar, an electronic device, a computer-readable storage medium, and a computer program product.

According to an aspect of the present disclosure, a data processing method for a virtual avatar is provided. The method includes: obtaining a target image including a face of a target object; performing facial keypoint extraction on the target image to obtain a first facial keypoint image; obtaining, based on the first facial keypoint image and a preset set of expression bases, a first set of expression coefficients corresponding to the first facial keypoint image, where the first set of expression coefficients are in one-to-one correspondence with the set of expression bases; adjusting a corresponding expression coefficient in the first set of expression coefficients to obtain a second set of expression coefficients corresponding to the target image that has undergone a facial expression transformation; obtaining a second facial keypoint image based on the second set of expression coefficients and the preset set of expression bases; and obtaining, based on the second facial keypoint image and the target image, a first image corresponding to the target image that has undergone the facial expression transformation.

According to another aspect of the present disclosure, a model training method is provided. The method includes: obtaining a first target image including a face of a target object and a first label image; performing facial keypoint extraction on the first target image to obtain a first facial keypoint image; obtaining, based on the first facial keypoint image and a preset set of expression bases, a first set of expression coefficients corresponding to the first facial keypoint image, where the first set of expression coefficients are in one-to-one correspondence with the set of expression bases; adjusting a corresponding expression coefficient in the first set of expression coefficients to obtain a second set of expression coefficients corresponding to the first target image that has undergone a facial expression transformation; obtaining a second facial keypoint image based on the second set of expression coefficients and the preset set of expression bases; obtaining, through a video generation model based on the second facial keypoint image and the first target image, a first image corresponding to the target image that has undergone the facial expression transformation; determining a first loss value by using a preset loss function based on the first image and the first label image; and adjusting a parameter value of the video generation model based on the first loss value.

According to another aspect of the present disclosure, an electronic device is provided. The electronic device includes: a memory storing one or more programs configured to be executed by one or more processors, the one or more programs including instructions for performing operations comprising: obtaining a target image comprising a face of a target object; performing facial keypoint extraction on the target image to obtain a first facial keypoint image; obtaining, based on the first facial keypoint image and a preset set of expression bases, a first set of expression coefficients corresponding to the first facial keypoint image, wherein the first set of expression coefficients are in one-to-one correspondence with the set of expression bases; adjusting a corresponding expression coefficient in the first set of expression coefficients to obtain a second set of expression coefficients corresponding to the target image that has undergone a facial expression transformation; obtaining a second facial keypoint image based on the second set of expression coefficients and the preset set of expression bases; and obtaining, based on the second facial keypoint image and the target image, a first image corresponding to the target image that has undergone the facial expression transformation.

It should be understood that the content described in this section is not intended to identify critical or important features of the embodiments of the present disclosure, and is not intended to limit the scope of the present disclosure. Other features of the present disclosure will be readily understood with reference to the following description.

### BRIEF DESCRIPTION OF THE DRAWINGS

The accompanying drawings show example embodiments and form a part of the specification, and are used to explain example implementations of the embodiments together with the written description of the specification. The embodiments shown are merely for illustrative purposes and do not limit the scope of the claims. Throughout the accompanying drawings, the same reference numerals denote similar but not necessarily same elements.

FIG. 1 is a schematic diagram of an example system in which various methods described herein can be implemented according to an embodiment of the present disclosure;

FIG. 2 is a flowchart of a data processing method according to an embodiment of the present disclosure;

FIG. 3 is a schematic diagram of a video generation model for video generation according to an embodiment of the present disclosure;

FIG. 4 is a flowchart of a model training method according to an embodiment of the present disclosure;

FIG. 5 is a structural block diagram of a data processing apparatus according to an embodiment of the present disclosure;

FIG. 6 is a structural block diagram of a model training apparatus according to an embodiment of the present disclosure; and

FIG. 7 is a structural block diagram of an example electronic device that can be used to implement an embodiment of the present disclosure.

### DETAILED DESCRIPTION OF EMBODIMENTS

Example embodiments of the present disclosure are described below in conjunction with the accompanying drawings, where various details of the embodiments of the present disclosure are included to facilitate understanding, and should only be considered as exemplary. Therefore, those of ordinary skill in the art should be aware that various changes and modifications can be made to the embodiments described here, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one component from another. In some examples, a first element and a second element may refer to a same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of the listed terms.

The embodiments of the present disclosure will be described below in detail with reference to the accompanying drawings.

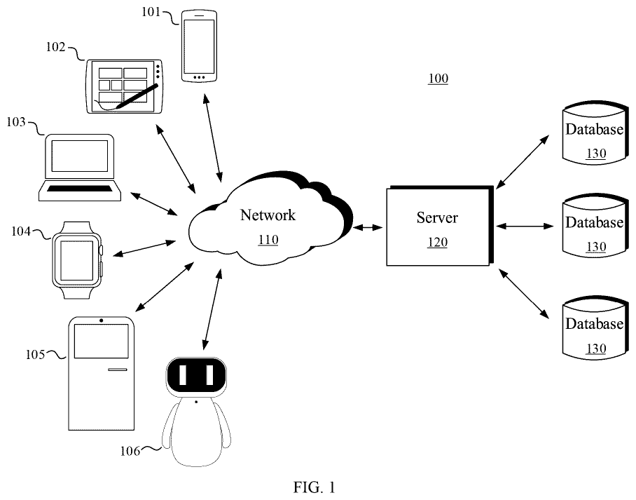

FIG. 1 is a schematic diagram of an example system 100 in which various methods and apparatuses described herein can be implemented according to an embodiment of the present disclosure. Referring to FIG. 1, the system 100 includes one or more client devices 101, 102, 103, 104, 105, and 106, a server 120, and one or more communication networks 110 that couple the one or more client devices to the server 120. The client devices 101, 102, 103, 104, 105, and 106 may be configured to execute one or more applications.

In an embodiment of the present disclosure, the server 120 can run one or more services or software applications that enable a data processing method to be performed.

In some embodiments, the server 120 may further provide other services or software applications that may include a non-virtual environment and a virtual environment. In some embodiments, these services may be provided as web-based services or cloud services, for example, provided to a user of the client devices 101, 102, 103, 104, 105, and/or 106 in a software-as-a-service (SaaS) model.

In the configuration shown in FIG. 1, the server 120 may include one or more components that implement functions performed by the server 120. These components may include software components, hardware components, or a combination thereof that can be executed by one or more processors. The user operating the client devices 101, 102, 103, 104, 105, and/or 106 may sequentially use one or more client applications to interact with the server 120, to use the services provided by these components. It should be understood that various different system configurations are possible, and may be different from that of the system 100. Therefore, FIG. 1 is an example of the system for implementing various methods described herein, and is not intended to be limiting.

The user may use the client devices 101, 102, 103, 104, 105, and/or 106 to input a target image, edit an expression coefficient, or display an image/video, etc. The client device may provide an interface that enables the user of the client device to interact with the client device. The client device may further output information to the user via the interface. Although FIG. 1 shows only six client devices, those skilled in the art will understand that any number of client devices are supported in the present disclosure.

The client devices 101, 102, 103, 104, 105, and/or 106 may include various types of computer devices, such as a portable handheld device, a general-purpose computer (such as a personal computer and a laptop computer), a workstation computer, a wearable device, a smart screen device, a self-service terminal device, a service robot, a gaming system, a thin client, various messaging devices, and a sensor or other sensing devices. These computer devices can run various types and versions of software applications and operating systems, such as MICROSOFT Windows, APPLE IOS, a UNIX-like operating system, and a Linux or Linux-like operating system (e.g., GOOGLE Chrome OS), or include various mobile operating systems, such as MICROSOFT Windows Mobile OS, iOS, Windows Phone, and Android. The portable handheld device may include a cellular phone, a smartphone, a tablet computer, a personal digital assistant (PDA), etc. The wearable device may include a head-mounted display (such as smart glasses) and other devices. The gaming system may include various handheld gaming devices, Internet-enabled gaming devices, etc. The client device can execute various applications, such as various Internet-related applications, communication applications (e.g., email applications), and short message service (SMS) applications, and can use various communication protocols.

The network 110 may be any type of network well known to those skilled in the art, and may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a blockchain network, a public switched telephone network (PSTN), an infrared network, a wireless network (such as Bluetooth or Wi-Fi), and/or any combination of these and/or other networks.

The server 120 may include one or more general-purpose computers, a dedicated server computer (for example, a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures related to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any one of the above-mentioned operating systems and any commercially available server operating system. The server 120 can also run any one of various additional server applications and/or middle-tier applications, including an HTTP server, an FTP server, a CGI server, a JAVA server, a database server, etc.

In some implementations, the server 120 may include one or more applications to analyze and merge data feeds and/or event updates received from users of the client devices 101, 102, 103, 104, 105, and 106. The server 120 may further include one or more applications to display the data feeds and/or real-time events via one or more display devices of the client devices 101, 102, 103, 104, 105, and 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 may further include one or more databases 130. In some embodiments, these databases can be used to store data and other information. For example, one or more of the databases 130 can be used to store information such as an image, an expression basis file, and a video file. The databases 130 may reside in various positions. For example, a database used by the server 120 may be locally in the server 120, or may be remote from the server 120 and may communicate with the server 120 via a network-based or dedicated connection. The database 130 may be of different types. In some embodiments, the database used by the server 120 may be, for example, a relational database. One or more of these databases can store, update, and retrieve data from or to the database, in response to a command.

In some embodiments, one or more of the databases 130 may further be used by an application to store application data. The database used by the application may be of different types, for example, may be a key-value repository, an object repository, or a regular repository backed by a file system.

The system 100 of FIG. 1 may be configured and operated in various manners, so that the various methods and apparatuses described according to the present disclosure can be applied.

In early research, researchers have achieved face reconstruction by constructing a parametric face model (e.g., a 3DMM). The 3DMM can model features such as shapes, expressions, textures, and angles, but a 3DMM-based face model rendering algorithm is poor in performance and incapable of generating high-precision detail regions such as textures and teeth.

Recently, deep learning-based methods have been widely studied for their good video generation effects. Two most representative methods are a GAN-based method (e.g., StyleGAN series) and a diffusion model-based method (e.g., Hallo, Follow-Your-Emoji, EchoMimic, and Aniportrait). Portraits generated through the GAN-based method are more realistic, but diversity thereof is greatly affected by data distribution. Moreover, a training process is unstable and prone to mode collapse. The diffusion model-based method allows for the generation of high-quality, high-resolution, and more diversified portrait videos, but requires more computational resources.

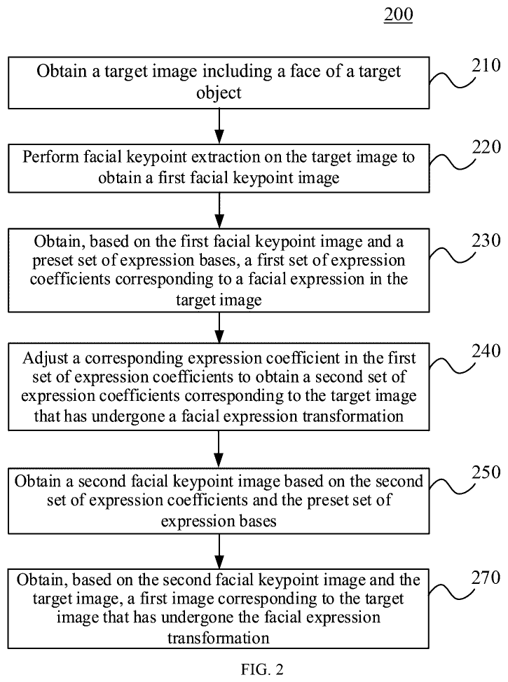

Therefore, according to an embodiment of the present disclosure, a data processing method for a virtual avatar is provided, to enable audio-driven generation of a corresponding portrait video. FIG. 2 is a flowchart of a data processing method according to an embodiment of the present disclosure. As shown in FIG. 2, the method 200 includes: obtaining a target image including a face of a target object (step 210); performing facial keypoint extraction on the target image to obtain a first facial keypoint image (step 220); obtaining, based on the first facial keypoint image and a preset set of expression bases, a first set of expression coefficients corresponding to a facial expression in the target image, where the first set of expression coefficients are in one-to-one correspondence with the set of expression bases (step 230); adjusting a corresponding expression coefficient in the first set of expression coefficients to obtain a second set of expression coefficients corresponding to the target image that has undergone a facial expression transformation (step 240); obtaining a second facial keypoint image based on the second set of expression coefficients and the preset set of expression bases (step 250); and obtaining, based on the second facial keypoint image and the target image, a first image corresponding to the target image that has undergone the facial expression transformation (step 260).

According to this embodiment of the present disclosure, operations are directly performed on facial keypoints based on the expression bases and the expression coefficients, to obtain the corresponding second facial keypoint image. Because computational time and resources required for subsequently generating the image corresponding to the target image that has undergone the facial expression transformation significantly exceed those for generating the second facial keypoint image, a generation effect of a subsequent image can be determined in advance based on the second facial keypoint image and an adjustment can be made in time, thereby saving computational resources.

In step 210, the target image including the face of the target object is obtained.

In the present disclosure, the target object may not be limited to a human, and may be an animal, an anthropomorphic animal or article, etc., which is not limited herein. Taking the target object being a real person as an example, the generated image may be an image obtained after a facial expression of a person in the target image is transformed. In some examples, the target object is used to generate a virtual digital human. The virtual digital human may be a two-dimensional virtual digital human generated based on the target object.

In some embodiments, the generated image may include not only the face of the target object, but also a background region in the target image other than the face of the target object.

In step 220, the facial keypoint extraction is performed on the target image to obtain the first facial keypoint image.

Specifically, in some examples, facial keypoint detection means locating a key region including, for example, an eyebrow, an eye, a nose, a mouth, a facial contour, etc. in a face image by using an algorithm. During the detection, the system returns coordinate information of these keypoints, thereby implementing fine-grained recognition and analysis of the face of the target object.

In some examples, during detection of the facial keypoints, a variety of appropriate keypoint annotation schemes such as 68-point annotation, 96/98-point annotation, and 106/186-point annotation may be implemented on a face, which is not limited herein. For example, during implementation of 68-point annotation on the face, the facial keypoints are divided into internal keypoints and contour keypoints, where the internal keypoints include a total of 51 keypoints of the eyebrows, eyes, nose, and mouth, and the contour keypoints include 17 keypoints. In this way, a facial keypoint image is obtained. The facial keypoint image may include coordinate information or position information of each keypoint.

According to some embodiments, the first facial keypoint image and the second facial keypoint image include coordinate information of a pupil keypoint.

In some examples, during the detection of the facial keypoints, the pupil keypoint may be further included. For an eye-related application scenario, for example, face recognition, expression transformation, and eye movement tracking, it is very important to precisely locate a pupil. Representing left and right pupils with two keypoints can provide more accurate position information, which helps with subsequent more fine-grained analysis and processing of expression transformation.

In some examples, three-dimensional face reconstruction may be performed on a first image by using a three-dimensional face reconstruction technology, to obtain a facial keypoint image of the target object. For example, 3D coordinates of the facial keypoints may be extracted using open-source plugins such as media pipe and facenet. Alternatively, it may be understood that 2D coordinates of the facial keypoints may be extracted using opencv and the like, which is not limited herein.

In step 230, the first set of expression coefficients corresponding to the facial expression in the target image are obtained based on the first facial keypoint image and the preset set of expression bases, where the first set of expression coefficients are in one-to-one correspondence with the set of expression bases.

In the present disclosure, the preset set of expression bases include morphable networks representing different expressions. Each morphable network is formed by a three-dimensional average face model of an animated avatar varying with different expressions, and may also be referred to as another shape derived from a base shape or a morph target. For example, the base shape may be a default shape, such as an expressionless face. Other shapes derived from the base shape are used for blending/morphing, and are different expressions (such as a blink of the left eye, a blink of the right eye, and a pout with the chin to the left). These shapes are collectively referred to as a blend shape or a morph target.

In the present disclosure, an expression coefficient is used to represent a magnitude (or degree) of an expression change corresponding to another shape (i.e., an expression basis) derived from the base shape. For example, if an expression basis represents a mouth morph based on the base shape (such as an expressionless face) to represent mouth open, an expression coefficient corresponding to the expression basis may be used to represent a degree of the mouth morph (i.e., a degree of the mouth open). For example, the expression coefficient corresponding to the expression basis corresponds to a range of [0, 1], where the expression coefficient equal to 0 represents a closed mouth, and the expression coefficient equal to 1 represents a fully open mouth.

For example, the driving of a virtual face model may be implemented based on formula (1):

$$H = {B}_{0} + {\sum }_{i = 1}^{n} {α}_{i} ( {B}_{i} - {B}_{0} ) \qquad ( 1 )$$

where B₀ represents an average face model of a virtual face model, i.e., the base shape, and a average face model is an expressionless face model. Bᵢ is an i^{th} expression basis of n expression bases used for forming the virtual face model through blending, and αᵢ represents an expression coefficient of the expression basis Bᵢ.

In some examples, based on the first facial keypoint image and the preset set of expression bases, the first set of expression coefficients corresponding to the facial expression in the target image may be determined according to formula (1). It may be understood that the first set of expression coefficients may alternatively be determined using any other appropriate set of expression bases and driving formulas, which is not limited herein.

In some examples, the preset set of expression bases represent a complete set of expression bases. That is, by using the set of expression bases, various representations of required facial expressions may be obtained through blending/morphing. For example, the set of expression bases may include 52 expressions in ARKit, where each expression includes a corresponding expression name and an expression coefficient representing a current expression magnitude thereof. Taking an expression basis representing eyeWideLeft in ARKit as an example, an expression coefficient of the expression basis gradually increases from 0 (i.e., eyeWideLeft=0) to 1 (i.e., eyeWideLeft=1), which indicates, in a corresponding face model, that a left eye gradually changes from a neutral state to a wide state.

In some examples, any set of expression coefficients may be in one-to-one correspondence with a preset complete set of expression bases. When a facial expression does not involve an expression change of a part, for example, an eye does not have any expression, an expression coefficient in the set of expression coefficients that corresponds to the expression change of the part may be 0.

In step 240, the corresponding expression coefficient in the first set of expression coefficients is adjusted to obtain the second set of expression coefficients corresponding to the target image that has undergone the facial expression transformation. And in step 250, the second facial keypoint image is obtained based on the second set of expression coefficients and the preset set of expression bases.

According to the above description, an expression coefficient is used to represent a magnitude (or degree) of an expression change corresponding to another shape (i.e., an expression basis) derived from the base shape. The corresponding expression coefficient is changed, so that a degree of a corresponding expression change of a corresponding part of the face can be changed, thereby achieving an expression transformation effect.

According to some embodiments, the target image and the second facial keypoint image have the same dimensionality.

In this embodiment, the target image and the second facial keypoint image have the same dimensionality, that is, data is aligned between images used for finally generating an expression-transformed image, better facilitating the improvement of a generation effect of the expression-transformed image.

According to some embodiments, obtaining, based on the second facial keypoint image and the target image, a first image corresponding to the target image that has undergone the facial expression transformation includes: generating an expression image based on the second facial keypoint image, where the expression image is generated based on a connection of facial keypoints related to an expression in the second facial keypoint image; and obtaining, based on the expression image and the target image, the first image corresponding to the target image that has undergone the facial expression transformation.

It may be understood that when the second facial keypoint image used to generate the expression image and the target image have the same dimensionality, the expression image generated based on the second facial keypoint image and the target image also have the same dimensionality. For example, the target image and the second facial keypoint image are both two-dimensional images or three-dimensional images. In this case, data is aligned between images used for finally generating an expression-transformed image, better facilitating the improvement of a generation effect of the expression-transformed image.

Usually, the input target image is a two-dimensional image. Therefore, according to some embodiments, the target image and the second facial keypoint image are both two-dimensional keypoint images, and each expression basis in the preset set of expression bases and the first facial keypoint image are both three-dimensional keypoint images.

It may be understood that three-dimensional face data has one more dimension of information than two-dimensional face data, and therefore three-dimensional face recognition is more advantageous than two-dimensional face recognition in terms of both recognition accuracy and living body detection accuracy. In the above-described embodiment, the expression bases formed based on the three-dimensional keypoint image allows for a more fine-grained expression change.

Therefore, in order to further improve the generation effect of the expression-transformed image, according to some embodiments, obtaining the second facial keypoint image based on the second set of expression coefficients and the preset set of expression bases includes: obtaining, based on the second set of expression coefficients and the preset set of expression bases, a third facial keypoint image obtained after expression transformation is performed on the face of the target object, where the third facial keypoint image includes coordinate information of a three-dimensional keypoint; and obtaining the second facial keypoint image based on the coordinate information of the three-dimensional keypoint and a preset first transformation matrix, where the second facial keypoint image includes coordinate information of a two-dimensional keypoint.

In some examples, there is a mapping relationship between a three-dimensional coordinate point of a face model and a two-dimensional coordinate point of a corresponding image, where the relationship may be represented by a 3*4 affine transformation matrix. It should be noted that each of the three-dimensional coordinate point of the face model and the two-dimensional coordinate point of the corresponding image is normalized, and has one more dimension than the original dimensionality. That is, the two-dimensional coordinate point of the image is denoted as X_{2D}=(Xᵢ, Yᵢ, 1)^{T}, and the three-dimensional coordinate point of the face model is denoted as X_{3D}=(Xᵢ, Yᵢ, Zᵢ, 1)^{T}. Two-dimensional-three-dimensional coordinate transformation is implemented according to formula (2):

$${X}_{2 D} = P \times {X}_{3 D} \qquad ( 2 )$$

where P represents an affine transformation matrix that needs to be calculated, which may be applied to a three-dimensional coordinate point to obtain coordinates of a corresponding two-dimensional point.

For example, during face recognition, three-dimensional keypoints of a face model and two-dimensional keypoints of a corresponding image are obtained by detecting facial keypoints (including eyes, a nose, a mouth, etc.). Then, an affine transformation matrix (i.e., the first transformation matrix) is calculated based on keypoint coordinates.

In some examples, the corresponding affine transformation matrix may be calculated using any appropriate algorithm that includes but is not limited to a gold standard algorithm. The calculated affine transformation matrix may be applied to a three-dimensional coordinate point to obtain coordinates of a corresponding two-dimensional point, thereby obtaining an aligned face image.

In some examples, an affine transformation matrix between three-dimensional-two-dimensional keypoint coordinates of a corresponding face model may be pre-calculated, and based on the affine transformation matrix, dimensional transformation may be subsequently performed on the second facial keypoint image obtained after expression coefficient adjustment.

According to some embodiments, obtaining the second facial keypoint image based on the second set of expression coefficients and the preset set of expression bases includes: obtaining, based on the second set of expression coefficients and the preset set of expression bases, a third facial keypoint image obtained after expression transformation is performed on the face of the target object, where the third facial keypoint image includes coordinate information of a three-dimensional keypoint; and obtaining the second facial keypoint image based on the coordinate information of the three-dimensional keypoint and a preset second transformation matrix, where the preset second transformation matrix is used to perform an operation on the face of the target object in a three-dimensional space, and the operation includes at least one of the following: rotation and translation.

In this embodiment, the rotation or movement of the face may be controlled through the rotation or translation operation. For example, a fine-grained control effect such as a five-degree head raise or a five-centimeter left movement may be achieved.

In some examples, to estimate a correspondence between two-dimensional and three-dimensional coordinate points, the affine transformation relationship described above may be further decomposed to derive a scaling factor, a rotation matrix, and a translation matrix. Through the corresponding rotation matrix and translation matrix, rotation and translation operations may be performed on the face of the target object in the three-dimensional space.

According to some embodiments, the second facial keypoint image includes coordinate information of a pupil keypoint. A pupil position is controlled, so that a fine-grained expression transformation effect can be achieved.

As described above, a key region including an eyebrow, an eye, a nose, a mouth, a facial contour, etc. in a face image may be located through the facial keypoint detection. Usually, keypoints of an eye region are keypoints of an orbital region. During the detection, the system returns coordinate information of these keypoints, for example, coordinate information of keypoints arranged around an orbit.

According to some embodiments, the coordinate information of the pupil keypoint is determined based on coordinate information of a keypoint of an orbital region in the second facial keypoint image.

In some examples, after the second facial keypoint image is obtained, the coordinate information of the pupil keypoint may be located and determined based on the coordinate information of the keypoint of the orbital region in the second facial keypoint image. Herein, a position of the pupil keypoint may be determined based on any appropriate number of orbital keypoints at any appropriate positions. For example, coordinates of the pupil keypoint may be determined based on keypoint coordinates at upper, lower, left, and right vertexes of the orbit.

It may be understood that the position of the pupil keypoint is set as a central position of an eye, and may alternatively be set at another appropriate position of the eye based on a changed expression, which is not limited herein.

According to some embodiments, adjusting the corresponding expression coefficient in the first set of expression coefficients to obtain the second set of expression coefficients corresponding to the target image that has undergone the facial expression change includes: adjusting the corresponding expression coefficient in the first set of expression coefficients a plurality of times to obtain a plurality of second sets of expression coefficients, where each second set of expression coefficient of the plurality of second sets of expression coefficients correspond to a transformed facial expression.

Specifically, a plurality of adjustments may be performed on the first set of expression coefficients, and each adjustment corresponds to a facial expression of the target object. Through the plurality of adjustments, a variety of different facial expressions of the target object are achieved.

According to some embodiments, adjusting the corresponding expression coefficient in the first set of expression coefficients a plurality of times to obtain the plurality of second sets of expression coefficients includes: obtaining video data including a face of a first object; segmenting the video data into frames to obtain a plurality of second images including the face of the first object; performing facial keypoint extraction on each of the plurality of second images to obtain a fourth facial keypoint image corresponding to each of the plurality of second images; obtaining, based on the fourth facial keypoint images and the preset set of expression bases, a third set of expression coefficients corresponding to each of the plurality of second images; determining, for each of the plurality of second images, a difference between a corresponding expression coefficient in the third set of expression coefficients corresponding to the second image and a corresponding expression coefficient in the third set of expression coefficients corresponding to a third image, to obtain a set of expression coefficient differences; and adjusting, for each second image, the corresponding expression coefficient in the first set of expression coefficients based on the set of expression coefficient differences corresponding to the second image, to obtain the plurality of second sets of expression coefficients.

In this embodiment, though a video-driven method, a facial expression of the target object is adjusted based on a facial expression of the first object in a video, to generate a high-precision face video based on the target image.

In the present disclosure, the obtained video data includes the face of the first object. The video data includes a plurality of facial video frame images of the first object. The face in the facial video frame image may be in any posture and any expression, as long as the face is clearly visible to allow for acquisition of reliable face features.

In the above-described embodiment, a gap between the third set of expression coefficients corresponding to the third image and the first set of expression coefficients corresponding to the target image is minimum. The “gap” may be determined based on a sum or a weighted sum of a corresponding set of expression coefficient differences. For example, it is assumed that the third set of expression coefficients is {0.2, 0.3, 0.7, 0.1} and the first set of expression coefficients is {0.5, 0.4, 0.6, 0.1}. In this case, a set of expression coefficient differences corresponding to the third set of expression coefficients and the first set of expression coefficients is {0.3, 0.1, 0.1, 0}, and the gap may be (0.3+0.1+0.1+0)=0.5. Alternatively, the gap may be determined based on the weighted sum of the set of expression coefficient differences.

In some examples, a weight value corresponding to a corresponding expression coefficient may be determined based on a degree of impact of an expression basis corresponding to the expression coefficient on an expression change. For example, a weight corresponding to an expression basis corresponding to a mouth is greater than a weight corresponding to an expression basis corresponding to an eye.

In some embodiments, adjusting, for each second image, the corresponding expression coefficient in the first set of expression coefficients based on the set of expression coefficient differences corresponding to the second image, to obtain the plurality of second sets of expression coefficients includes: adjusting, for each second image, a corresponding expression coefficient in the first set of expression coefficients based on the set of expression coefficient differences corresponding to the second image, to obtain a plurality of fourth sets of expression coefficients; determining a corresponding expression coefficient difference between a corresponding expression coefficient in the third set of expression coefficients corresponding to the third image and a corresponding expression coefficient in the first set of expression coefficients corresponding to the target image; and obtaining the plurality of second sets of expression coefficients based on the plurality of fourth sets of expression coefficients and the expression coefficient difference calculated based on the third image and the target image.

Specifically, it is assumed that the above-mentioned gap is A, an expression coefficient corresponding to the target image is [a] (assuming that only one expression is included), and expression coefficients respectively corresponding to a plurality of image frames of the video data are a sequence [b, c, d, e, f, g] (assuming that each image frame also includes only the same expression); and it is assumed that, for example, a gap between e and a is minimum, i.e., A=e−a. In this case, the plurality of second sets of expression coefficients obtained are a sequence [a+(b−e)+A, a+(c−e)+A, a+(d−e)+A, a+(e−e)+A, a+(f−e)+A, a+(g−e)+A].

Therefore, according to some embodiments, obtaining the second facial keypoint image based on the second set of expression coefficients and the preset set of expression bases includes: obtaining a second facial keypoint image sequence based on the plurality of second sets of expression coefficients and the preset set of expression bases, where images in the second facial keypoint image sequence are in one-to-one correspondence with the plurality of second sets of expression coefficients.

In step 260, the first image corresponding to the target image that has undergone the facial expression transformation is obtained based on the second facial keypoint image and the target image.

According to some embodiments, obtaining, based on the second facial keypoint image and the target image, the first image corresponding to the target image that has undergone the facial expression transformation includes: generating an expression image based on the second facial keypoint image, where the expression image is generated based on a connection of facial keypoints related to an expression in the second facial keypoint image; obtaining, based on the expression image and the target image, the first image corresponding to the target image that has undergone the facial expression transformation.

In some examples, the expression image may include lines connecting some keypoints of eyes, a mouth, eyebrows, and a facial contour below the eyes or eyebrows. Usually, there is almost no or a slight change in a nose part during a facial expression change. Therefore, the nose part may be ignored in the expression image by refraining from connecting nose keypoints.

In the above-described example of the detection of the facial keypoints including the pupil keypoint, the expression image may further include information about the pupil keypoint. In this way, more accurate face position information is provided to help with subsequent more fine-grained analysis and processing.

In the case where the second facial keypoint image sequence is generated as described above, according to some embodiments, obtaining, based on the second facial keypoint image and the target image, the first image corresponding to the target image that has undergone the facial expression transformation includes: generating an expression image sequence based on the second facial keypoint image sequence; and obtaining, based on the expression image sequence and the target image, a plurality of first images corresponding to the target image that has undergone a plurality of facial expression transformations, where the plurality of images are in one-to-one correspondence with expression images in the expression image sequence.

In some examples, the plurality of first images may alternatively be feature maps.

According to some embodiments, the first image corresponding to the target image that has undergone the facial expression transformation is obtained through the following operations: performing image feature extraction on the target image to obtain a first image feature; performing image feature extraction on the expression image to obtain a second image feature; inputting the first image feature and the second image feature into a preset diffusion model to obtain a third image feature; and obtaining, based on the third image feature, the first image corresponding to the target image that has undergone the facial expression transformation.

In the present disclosure, image feature extraction is a process of extracting useful information from an image. The information is usually represented in the form of numerical values, vectors, or symbols, and is not directly represented as the image. These features may help computers “understand” image content, thereby implementing image recognition and classification. An image feature usually includes a geometric feature, a shape feature, a magnitude feature, a histogram feature, a color feature, etc.

In some examples, the image feature extraction may be performed on the target image through an image encoder, to obtain the first image feature. The image encoder is a component configured to process visual information, which converts image data into a format that can be further analyzed by a model. This usually involves feature extraction, i.e., extraction of useful information such as a color, a texture, a shape, and an object position from an image.

According to some embodiments, performing the image feature extraction on the target image to obtain the first image feature includes: inputting the target image into an encoder of a variational autoencoder to obtain the first image feature.

In some examples, image feature extraction may be performed through a deep learning-based neural network, for example, a convolutional neural network (CNN). The CNN automatically learns features through a multilayer network, without a feature extraction rule set manually. VGG and ResNet are two well-known CNN architectures that extract image features through deep network structures.

It may be understood that image feature extraction may be implemented in this embodiment of the present disclosure through any appropriate method, which is not limited herein.

According to some embodiments, the method further includes: performing video synthesis based on the plurality of first images to obtain a video generated based on the target image.

According to some embodiments, obtaining, based on the plurality of first images, the video generated based on the target image includes: inputting the plurality of first images into a decoder of the variational autoencoder to obtain the video generated based on the target image.

According to some embodiments, performing video synthesis based on the plurality of first images to obtain the video generated based on the target image includes: performing image feature extraction on the target image to obtain a first image feature; performing image feature extraction on the expression image sequence to obtain a second image feature sequence; inputting the first image feature and the second image feature sequence into an image generation module to obtain a fourth image feature sequence, where an image feature in the fourth image feature is an image feature that is generated based on the target image and corresponding to a corresponding image feature in the second image feature sequence; inputting the fourth image feature sequence into a video synthesis module to obtain the plurality of first images, where the first image of the plurality of first images is a feature map, and the video synthesis module is configured to achieve smoothness of a video generated based on the plurality of first images; and obtaining, based on the plurality of first images, the video generated based on the target image.

In some examples, each image feature in the fourth image feature is an image feature that is generated based on the target image and corresponding to a corresponding image feature in the second image feature sequence. Each of the plurality of first images is a feature map.

According to some embodiments, the corresponding second image feature is obtained through a preset linear attention network.

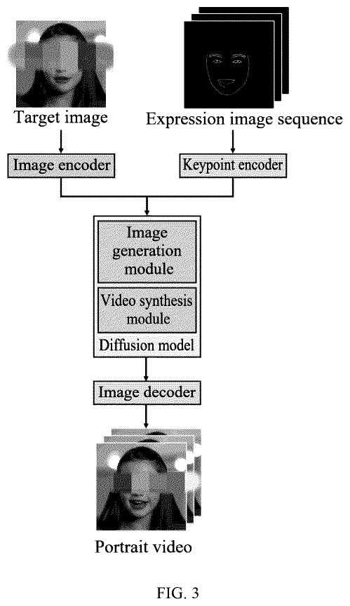

FIG. 3 is a schematic diagram of a video generation model for video generation according to an embodiment of the present disclosure. As shown in FIG. 3, a target image is input into an image encoder to obtain a first image feature; an expression image sequence is input into a keypoint encoder to obtain a second image feature sequence; and the first image feature and the second image feature sequence are sequentially input into an image generation module and a video synthesis module in a diffusion model, to obtain a plurality of first images (i.e., feature maps). The plurality of first images are passed through an image decoder to obtain a video generated based on the target image. In some examples, a body of the diffusion model may be based on a Unet framework, the image generation module is responsible for target object generation and image background supplementation for a single image, and the video synthesis module is responsible for the smoothness and stability of an entire video to be generated.

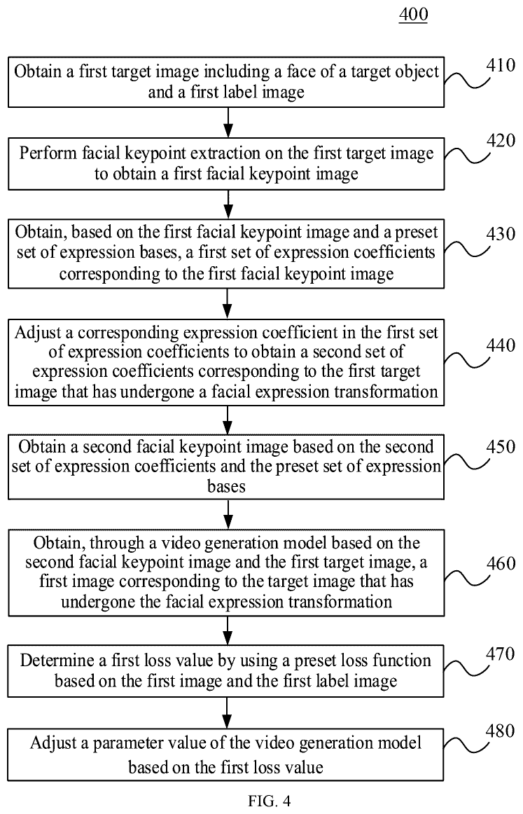

According to an embodiment of the present disclosure, as shown in FIG. 4, a model training method 400 is further provided. The method includes the following steps: obtaining a first target image including a face of a target object and a first label image (step 410); performing facial keypoint extraction on the first target image to obtain a first facial keypoint image (step 420); obtaining, based on the first facial keypoint image and a preset set of expression bases, a first set of expression coefficients corresponding to the first facial keypoint image, where the first set of expression coefficients are in one-to-one correspondence with the set of expression bases (step 430); adjusting a corresponding expression coefficient in the first set of expression coefficients to obtain a second set of expression coefficients corresponding to the first target image that has undergone a facial expression transformation (step 440); obtaining a second facial keypoint image based on the second set of expression coefficients and the preset set of expression bases (step 450); obtaining, through a video generation model based on the second facial keypoint image and the first target image, a first image corresponding to the target image that has undergone the facial expression transformation (step 460); determining a first loss value by using a preset loss function based on the first image and the first label image (step 470); and adjusting a parameter value of the video generation model based on the first loss value (step 480).

According to some embodiments, the target image and the second facial keypoint image have the same dimensionality.

In this embodiment, the target image and the second facial keypoint image have the same dimensionality, that is, data is aligned between images used for finally generating an expression-transformed image, better facilitating the improvement of a generation effect of the expression-transformed image.

According to some embodiments, obtaining, through the video generation model based on the second facial keypoint image and the first target image, the first image corresponding to the target image that has undergone the facial expression transformation includes: generating a first expression image based on the second facial keypoint image, where the first expression image is generated based on a connection of facial keypoints related to an expression in the second facial keypoint image; and inputting the first expression image and the target image into the video generation model to obtain the first image corresponding to the target image that has undergone the facial expression transformation.

It may be understood that when the second facial keypoint image used to generate the expression image and the target image have the same dimensionality, the expression image generated based on the second facial keypoint image and the target image also have the same dimensionality. For example, the target image and the second facial keypoint image are both two-dimensional images or three-dimensional images. In this case, data is aligned between images used for finally generating an expression-transformed image, better facilitating the improvement of model learning and a training effect.

Usually, the input target image is a two-dimensional image. Therefore, according to some embodiments, the first target image and the second facial keypoint image are both two-dimensional keypoint images, and each expression basis in the preset set of expression bases and the first facial keypoint image are both three-dimensional keypoint images.

It may be understood that three-dimensional face data has one more dimension of information than two-dimensional face data, and therefore three-dimensional face recognition is more advantageous than two-dimensional face recognition in terms of both recognition accuracy and living body detection accuracy. In the above-described embodiment, the expression bases formed based on the three-dimensional keypoint image allows for a more fine-grained expression change.

Therefore, in order to further improve the generation effect of the expression-transformed image, according to some embodiments, obtaining the second facial keypoint image based on the second set of expression coefficients and the preset set of expression bases includes: obtaining, based on the second set of expression coefficients and the preset set of expression bases, a third facial keypoint image obtained after expression transformation is performed on the face of the target object, where the third facial keypoint image includes coordinate information of a three-dimensional keypoint; and obtaining the second facial keypoint image based on the coordinate information of the three-dimensional keypoint and a preset first transformation matrix, where the second facial keypoint image includes coordinate information of a two-dimensional keypoint.

According to some embodiments, obtaining the second facial keypoint image based on the second set of expression coefficients and the preset set of expression bases includes: obtaining, based on the second set of expression coefficients and the preset set of expression bases, a third facial keypoint image obtained after expression transformation is performed on the face of the target object, where the third facial keypoint image includes coordinate information of a three-dimensional keypoint; and obtaining the second facial keypoint image based on the coordinate information of the three-dimensional keypoint and a preset second transformation matrix, where the preset second transformation matrix is used to perform an operation on the face of the target object in a three-dimensional space, and the operation includes at least one of the following: rotation and translation.

According to some embodiments, the second facial keypoint image includes coordinate information of a pupil keypoint. A pupil position is controlled, so that a fine-grained expression transformation effect can be achieved.

According to some embodiments, the coordinate information of the pupil keypoint is determined based on coordinate information of a keypoint of an orbital region in the second facial keypoint image.

According to some embodiments, the video generation model includes a first image encoder, a second image encoder, a diffusion model, and an image decoder. Inputting the first expression image and the first target image into the video generation model to obtain the second image corresponding to the target image that has undergone the facial expression transformation includes: inputting the first target image into the first image encoder to obtain a first image feature; inputting the first expression image into the second image encoder to obtain a second image feature; inputting the first image feature and the second image feature into the diffusion model to obtain a third image feature; and obtaining, based on the third image feature, the first image corresponding to the target image that has undergone the facial expression transformation.

In some examples, image feature extraction may be performed through a deep learning-based neural network. That is, at least one of the first image encoder and the second image encoder may be a deep learning-based neural network, for example, a convolutional neural network (CNN). The CNN automatically learns features through a multilayer network, without a feature extraction rule set manually. VGG and ResNet are two well-known CNN architectures that extract image features through deep network structures.

It may be understood that image feature extraction may be implemented in this embodiment of the present disclosure through any appropriate method, which is not limited herein.

According to some embodiments, the first image encoder may include an encoder of variational autoencoder to obtain the first image feature. According to some embodiments, a video generated based on the target image may be obtained based on a plurality of first images. For example, the plurality of first images are input into the a decoder of variational autoencoder to obtain the video generated based on the image.

Therefore, according to some embodiments, adjusting the parameter value of the video generation model based on the first loss value includes: adjusting parameter values of the second image encoder and the diffusion model based on the first loss value.

According to some embodiments, the diffusion model includes an image generation module and a video synthesis module, and inputting the first image feature and the second image feature into the diffusion model to obtain the third image feature includes: inputting the first image feature and the second image feature into the image generation module to obtain a fourth image feature, where the fourth image feature is an image feature that is generated based on the target image and corresponding to the second image feature; and inputting the fourth image feature into the video synthesis module to obtain the third image feature, where the video synthesis module is configured to achieve smoothness of a video during generation of the video based on a plurality of second image features.

According to some embodiments, adjusting the parameter value of the video generation model based on the first loss value includes: adjusting parameter values of the second image encoder and the image generation module based on the first loss value.

According to some embodiments, the model training method according to the present disclosure further includes: obtaining a plurality of second expression images, a second target image including the face of the target object, and a plurality of second label images in one-to-one correspondence with the plurality of second expression images, where each of the plurality of second expression images is generated based on a connection of facial keypoints related to an expression in a corresponding facial keypoint image; inputting the second target image into the first image encoder to obtain a fifth image feature; inputting the plurality of second expression images into the second image encoder to obtain a plurality of sixth image features; inputting the fifth image feature and the plurality of sixth image features into the image generation module to obtain a plurality of seventh image features, where the plurality of seventh image features are in one-to-one correspondence with the plurality of sixth image features; inputting the plurality of seventh image features into the video synthesis module to obtain a plurality of eighth image features; inputting the plurality of eighth image features into the image decoder to obtain a plurality of second images; determining a second loss value by using the preset loss function based on the plurality of second images and the plurality of second label images; and adjusting a parameter value of the video synthesis module based on the second loss value.

Specifically, in some examples, training of the video generation model may include two phases. That is, in a first stage, the second image encoder and the image generation module are trained based on a single frame of expression image; and in a second stage, the video synthesis module is trained based on a plurality of frames of expression images.

According to some embodiments, the second image encoder includes a linear attention network.

According to some embodiments, the preset loss function loss is determined based on the following formula:

$$loss = a \times ( C - \overline{C} ) + b \times ( D \times C - D \times \overline{C} )$$

where C̅ represents the first label image or a corresponding second label image of the plurality of second label images, C represents the first image or a corresponding second image of the plurality of second images, D represents a mouth mask image, and a and b are both preset hyperparameters.

In some examples, when C̅ represents a corresponding second label image of the plurality of second label images, and C represents a corresponding second image of the plurality of second images, a loss value corresponding to each image of the plurality of second label images/second images may be calculated by using the above-described formula, and the second loss value may be obtained by summing up loss values respectively corresponding to the plurality of second label images/second images, to adjust the parameter value of the video synthesis module based on the second loss value.

In this embodiment, to improve the clarity and stability of tooth generation, both a mouth mask loss and an overall image loss are used to supervise model training. Moreover, in some examples, appropriate a and b are set, so that a weight of the mouth mask loss can be increased to further improve the clarity and stability of tooth generation.

In the present disclosure, a model trained through the model training method according to any one of the embodiments described above may be used to implement the data processing method according to any one of the embodiments of the present disclosure.

Herein, the corresponding operations in the embodiment for implementing the model training method are similar to those in the embodiment for implementing the data processing method. Details are not described herein again.

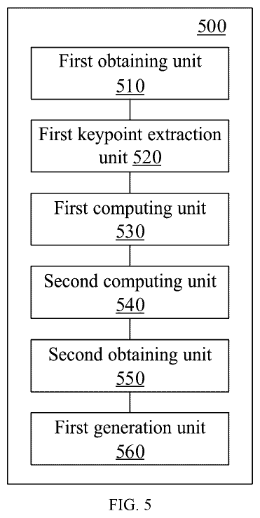

According to an embodiment of the present disclosure, as shown in FIG. 5, a data processing apparatus 500 for a virtual avatar is further provided. The apparatus includes: a first obtaining unit 510 configured to obtain a target image including a face of a target object; a first keypoint extraction unit 520 configured to perform facial keypoint extraction on the target image to obtain a first facial keypoint image; a first computing unit 530 configured to obtain, based on the first facial keypoint image and a preset set of expression bases, a first set of expression coefficients corresponding to the first facial keypoint image, where the first set of expression coefficients are in one-to-one correspondence with the set of expression bases; a second computing unit 540 configured to adjust a corresponding expression coefficient in the first set of expression coefficients to obtain a second set of expression coefficients corresponding to the target image that has undergone a facial expression transformation; a second obtaining unit 550 configured to obtain a second facial keypoint image based on the second set of expression coefficients and the preset set of expression bases; and a first generation unit 560 configured to obtain, based on the second facial keypoint image and the target image, a first image corresponding to the target image that has undergone the facial expression transformation.

Herein, the operations of the units 510 to 560 of the data processing apparatus 500 are respectively similar to the operations of steps 210 to 260 described above. Details are not described herein again.

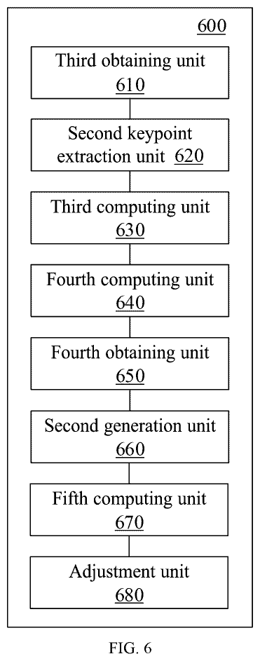

According to an embodiment of the present disclosure, as shown in FIG. 6, a model training apparatus 600 is further provided. The apparatus includes: a third obtaining unit 610 configured to obtain a first target image including a face of a target object and a first label image; a second keypoint extraction unit 620 configured to perform facial keypoint extraction on the first target image to obtain a first facial keypoint image; a third computing unit 630 configured to obtain, based on the first facial keypoint image and a preset set of expression bases, a first set of expression coefficients corresponding to the first facial keypoint image, where the first set of expression coefficients are in one-to-one correspondence with the set of expression bases; a fourth computing unit 640 configured to adjust a corresponding expression coefficient in the first set of expression coefficients to obtain a second set of expression coefficients corresponding to the first target image that has undergone a facial expression transformation; a fourth obtaining unit 650 configured to obtain a second facial keypoint image based on the second set of expression coefficients and the preset set of expression bases; a second generation unit 660 configured to obtain, through a video generation model based on the second facial keypoint image and the first target image, a first image corresponding to the target image that has undergone the facial expression transformation; a fifth computing unit 670 configured to determine a first loss value by using a preset loss function based on the first image and the first label image; and an adjustment unit 680 configured to adjust a parameter value of the video generation model based on the first loss value.

Here, the operations of the units 610 to 680 of the model training apparatus 600 are respectively similar to the operations of steps 410 to 480 described above. Details are not described herein again.

In the technical solutions of the present disclosure, collection, storage, use, processing, transmission, provision, disclosure, etc. of user personal information involved all comply with related laws and regulations and are not against the public order and good morals.

According to an embodiment of the present disclosure, an electronic device, a readable storage medium, and a computer program product are further provided.

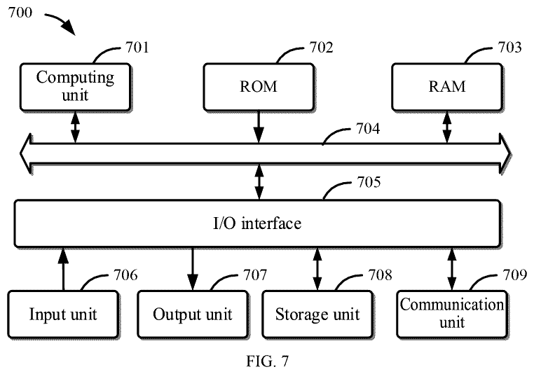

Referring to FIG. 7, a structural block diagram of an electronic device 700 will be described below, which can serve as a server or a client of the present disclosure and is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown in the present specification, their connections and relationships, and their functions are merely examples, and are not intended to limit the implementation of the present disclosure described and/or required herein.

As shown in FIG. 7, the electronic device 700 includes a computing unit 701, the computing unit may perform various appropriate actions and processing according to a computer program stored in a read-only memory (ROM) 702 or a computer program loaded from a storage unit 708 to a random access memory (RAM) 703. The RAM 703 may further store various programs and data required for the operation of the electronic device 700. The computing unit 701, the ROM 702, and the RAM 703 are connected to each other through a bus 704. An input/output (I/O) interface 705 is also connected to the bus 704.

A plurality of components in the electronic device 700 are connected to the I/O interface 705, including: an input unit 706, an output unit 707, the storage unit 708, and a communication unit 709. The input unit 706 may be any type of device capable of inputting information to the electronic device 700, the input unit 706 may receive input digit or character information and generate a key signal input related to user settings and/or function control of the electronic device, and may include, but is not limited to, a mouse, a keyboard, a touchscreen, a trackpad, a trackball, a joystick, a microphone, and/or a remote controller. The output unit 707 may be any type of device capable of presenting information, and may include, but is not limited to, a display, a speaker, a video/audio output terminal, a vibrator, and/or a printer. The storage unit 708 may include, but is not limited to, a magnetic disk and an optical disk. The communication unit 709 allows the electronic device 700 to exchange information/data with other devices via a computer network such as the Internet and/or various telecommunication networks, and may include, but is not limited to, a modem, a network interface card, an infrared communication device, a wireless communication transceiver, and/or a chipset, for example, a Bluetooth device, an 802.11 device, a Wi-Fi device, a WiMax device, and/or a cellular communication device.

The computing unit 701 may be various general-purpose and/or special-purpose processing components with processing and computing capabilities. Some examples of the computing unit 701 include, but are not limited to, a central processing unit (CPU), a graphics processing unit (GPU), various dedicated artificial intelligence (AI) computing chips, various computing units on which machine learning model algorithms run, a digital signal processor (DSP), and any appropriate processor, controller, microcontroller, etc. The computing unit 701 performs the various methods and processing described above, for example, the method 200 or 400. For example, in some embodiments, the method 200 or 400 may be implemented as a computer software program, which is tangibly contained in a machine-readable medium, such as the storage unit 708. In some embodiments, a part or all of the computer program may be loaded and/or installed onto the electronic device 700 via the ROM 702 and/or the communication unit 709. When the computer program is loaded onto the RAM 703 and executed by the computing unit 701, one or more steps of the method 200 or 400 described above can be performed. Alternatively, in other embodiments, the computing unit 701 may be configured, by any other suitable means (for example, by means of firmware), to perform the method 200 or 400.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logic device (CPLD), computer hardware, firmware, software, and/or a: combination thereof. These various implementations may include: implementation in one or more computer programs, where the one or more computer programs may be executed and/or interpreted on a programmable system including at least one programmable processor. The programmable processor may be a dedicated or general-purpose programmable processor that can receive data and instructions from a storage system, at least one input means, and at least one output means, and transmit data and instructions to the storage system, the at least one input apparatus, and the at least one output means.

Program codes used to implement the method of the present disclosure can be written in any combination of one or more programming languages. The program code may be provided for a processor or a controller of a general-purpose computer, a special-purpose computer, or other programmable data processing apparatuses, such that when the program code is executed by the processor or the controller, the functions/operations specified in the flowcharts and/or block diagrams are implemented. The program code may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing means (for example, a mouse or a trackball) through which the user can provide an input to the computer. Other categories of apparatuses can also be used to provide interaction with the user; for example, feedback provided to the user can be any form of sensory feedback (for example, visual feedback, auditory feedback, or tactile feedback); and an input from the user can be received in any form (including an acoustic input, a voice input, or a tactile input).

The systems and technologies described herein can be implemented in a computing system including a backend component (for example, as a data server), in a computing system including a middleware component (for example, an application server), in a computing system including a frontend component (for example, a user computer with a graphical user interface or a web browser through which the user can interact with the implementation of the systems and technologies described herein), or in a computing system including any combination of the backend component, the middleware component, and the frontend component. The components of the system can be connected to each other through digital data communication (for example, a communication network) in any form or medium. Examples of the communication network include: a local area network (LAN), a wide area network (WAN), the Internet, and a blockchain network.

A computer system may include a client and a server. The client and the server are generally far away from each other and usually interact through a communication network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, successively, or in a different order, provided that the desired result of the technical solutions disclosed in the present disclosure can be achieved, which is not limited herein.

Although the embodiments or examples of the present disclosure have been described with reference to the accompanying drawings, it should be appreciated that the method, system, and device described above are merely exemplary embodiments or examples, and the scope of the present disclosure is not limited by the embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A data processing method for a virtual avatar, comprising:
obtaining a target image comprising a face of a target object;
performing facial keypoint extraction on the target image to obtain a first facial keypoint image;
obtaining, based on the first facial keypoint image and a preset set of expression bases, a first set of expression coefficients corresponding to the first facial keypoint image, wherein the first set of expression coefficients are in one-to-one correspondence with the set of expression bases;
adjusting a corresponding expression coefficient in the first set of expression coefficients to obtain a second set of expression coefficients corresponding to the target image that has undergone a facial expression transformation;
obtaining a second facial keypoint image based on the second set of expression coefficients and the preset set of expression bases; and
obtaining, based on the second facial keypoint image and the target image, a first image corresponding to the target image that has undergone the facial expression transformation.

2. The method according to claim 1, wherein the target image and the second facial keypoint image are both two-dimensional keypoint images, each expression basis in the preset set of expression bases and the first facial keypoint image are both three-dimensional keypoint images, and obtaining the second facial keypoint image based on the second set of expression coefficients and the preset set of expression bases comprises:
obtaining, based on the second set of expression coefficients and the preset set of expression bases, a third facial keypoint image obtained after an expression transformation is performed on the face of the target object, wherein the third facial keypoint image comprises coordinate information of a three-dimensional keypoint; and
obtaining the second facial keypoint image based on the coordinate information of the three-dimensional keypoint and a preset first transformation matrix, wherein the second facial keypoint image comprises coordinate information of a two-dimensional keypoint.

3. The method according to claim 1, wherein obtaining the second facial keypoint image based on the second set of expression coefficients and the preset set of expression bases comprises:
obtaining, based on the second set of expression coefficients and the preset set of expression bases, a third facial keypoint image obtained after the expression transformation is performed on the face of the target object, wherein the third facial keypoint image comprises coordinate information of a three-dimensional keypoint; and
obtaining the second facial keypoint image based on the coordinate information of the three-dimensional keypoint and a preset second transformation matrix, wherein the preset second transformation matrix is used to perform an operation on the face of the target object in a three-dimensional space, and the operation comprises at least one of the following: rotation and translation.

4. The method according to claim 1, wherein the second facial keypoint image comprises coordinate information of a pupil keypoint.

5. The method according to claim 1, wherein:
adjusting the corresponding expression coefficient in the first set of expression coefficients to obtain the second set of expression coefficients corresponding to the target image that has undergone the facial expression transformation comprises:
adjusting the corresponding expression coefficient in the first set of expression coefficients a plurality of times to obtain a plurality of second sets of expression coefficients, wherein each second set of expression coefficients of the plurality of second sets of expression coefficients correspond to a transformed facial expression; and
obtaining the second facial keypoint image based on the second set of expression coefficients and the preset set of expression bases comprises:
obtaining a second facial keypoint image sequence based on the plurality of second sets of expression coefficients and the preset set of expression bases, wherein images in the second facial keypoint image sequence are in one-to-one correspondence with the plurality of second sets of expression coefficients.

6. The method according to claim 5, wherein adjusting the corresponding expression coefficient in the first set of expression coefficients a plurality of times to obtain the plurality of second sets of expression coefficients comprises:
obtaining video data comprising the face of a first object;
segmenting the video data into frames to obtain a plurality of second images comprising the face of the first object;
performing facial keypoint extraction on each of the plurality of second images to obtain a fourth facial keypoint image corresponding to each of the plurality of second images;
obtaining, based on the fourth facial keypoint image and the preset set of expression bases, a third set of expression coefficients corresponding to each of the plurality of second images;
determining, for each of the plurality of second images, a difference between a corresponding expression coefficient in the third set of expression coefficients corresponding to the second image and a corresponding expression coefficient in the third set of expression coefficients corresponding to a third image, to obtain a set of expression coefficient differences; and
adjusting, for each second image, the corresponding expression coefficient in the first set of expression coefficients based on the set of expression coefficient differences corresponding to the second image, to obtain the plurality of second sets of expression coefficients, wherein
a gap between the third set of expression coefficients corresponding to the third image and the first set of expression coefficients corresponding to the target image is minimum.

7. The method according to claim 1, wherein obtaining, based on the second facial keypoint image and the target image, the first image corresponding to the target image that has undergone the facial expression transformation comprises:
generating an expression image based on the second facial keypoint image, wherein the expression image is generated based on a connection of facial keypoints related to an expression in the second facial keypoint image; and
obtaining, based on the expression image and the target image, the first image corresponding to the target image that has undergone the facial expression transformation.

8. The method according to claim 7, wherein obtaining, based on the second facial keypoint image and the target image, the first image corresponding to the target image that has undergone the facial expression transformation comprises:
generating an expression image sequence based on a second facial keypoint image sequence; and
obtaining, based on the expression image sequence and the target image, a plurality of first images corresponding to the target image that has undergone a plurality of facial expression transformations, wherein the plurality of first images are in one-to-one correspondence with expression images in the expression image sequence.

9. The method according to claim 7, wherein the first image corresponding to the target image that has undergone the facial expression transformation is obtained through the following operations:
performing image feature extraction on the target image to obtain a first image feature;
performing image feature extraction on the expression image to obtain a second image feature;
inputting the first image feature and the second image feature into a preset diffusion model to obtain a third image feature; and
obtaining, based on the third image feature, the first image corresponding to the target image that has undergone the facial expression transformation.

10. The method according to claim 8, further comprising: performing video synthesis based on the plurality of first images to obtain a video generated based on the target image, wherein performing the video synthesis based on the plurality of first images to obtain the video generated based on the target image comprises:
performing image feature extraction on the target image to obtain a first image feature;
performing image feature extraction on the expression image sequence to obtain a second image feature sequence;
inputting the first image feature and the second image feature sequence into an image generation module to obtain a fourth image feature sequence, wherein an image feature in the fourth image feature sequence is an image feature that is generated based on the target image and corresponding to a corresponding image feature in the second image feature sequence;
inputting the fourth image feature sequence into a video synthesis module to obtain the plurality of first images, wherein each of the plurality of first images is a feature map, and the video synthesis module is configured to achieve smoothness of a video generated based on the plurality of first images; and
obtaining, based on the plurality of first images, the video generated based on the target image.

11. The method according to claim 10, wherein
performing the image feature extraction on the target image to obtain the first image feature comprises: inputting the target image into an encoder of a variational autoencoder to obtain the first image feature; and
obtaining, based on the plurality of first images, the video generated based on the target image comprises: inputting the plurality of first images into a decoder of the variational autoencoder to obtain the video generated based on the target image.

12. A model training method, comprising:
obtaining a first target image comprising a face of a target object and a first label image;
performing facial keypoint extraction on the first target image to obtain a first facial keypoint image;
obtaining, based on the first facial keypoint image and a preset set of expression bases, a first set of expression coefficients corresponding to the first facial keypoint image, wherein the first set of expression coefficients are in one-to-one correspondence with the set of expression bases;
adjusting a corresponding expression coefficient in the first set of expression coefficients to obtain a second set of expression coefficients corresponding to the first target image that has undergone a facial expression transformation;
obtaining a second facial keypoint image based on the second set of expression coefficients and the preset set of expression bases;
obtaining, through a video generation model based on the second facial keypoint image and the first target image, a first image corresponding to the target image that has undergone the facial expression transformation;
determining a first loss value by using a preset loss function based on the first image and the first label image; and
adjusting a parameter value of the video generation model based on the first loss value.

13. The method according to claim 12, wherein the first target image and the second facial keypoint image are both two-dimensional keypoint images, each expression basis in the preset set of expression bases and the first facial keypoint image are both three-dimensional keypoint images, and obtaining the second facial keypoint image based on the second set of expression coefficients and the preset set of expression bases comprises:
obtaining, based on the second set of expression coefficients and the preset set of expression bases, a third facial keypoint image obtained after an expression transformation is performed on the face of the target object, wherein the third facial keypoint image comprises coordinate information of a three-dimensional keypoint; and
obtaining the second facial keypoint image based on the coordinate information of the three-dimensional keypoint and a preset first transformation matrix, wherein the second facial keypoint image comprises coordinate information of a two-dimensional keypoint.

14. The method according to claim 12, wherein obtaining the second facial keypoint image based on the second set of expression coefficients and the preset set of expression bases comprises:
obtaining, based on the second set of expression coefficients and the preset set of expression bases, a third facial keypoint image obtained after the expression transformation is performed on the face of the target object, wherein the third facial keypoint image comprises coordinate information of a three-dimensional keypoint; and
obtaining the second facial keypoint image based on the coordinate information of the three-dimensional keypoint and a preset second transformation matrix, wherein the preset second transformation matrix is used to perform an operation on the face of the target object in a three-dimensional space, and the operation comprises at least one of the following: rotation and translation.

15. The method according to claim 12, wherein the second facial keypoint image comprises coordinate information of a pupil keypoint.

16. The method according to claim 12, wherein obtaining, through the video generation model based on the second facial keypoint image and the first target image, the first image corresponding to the target image that has undergone the facial expression transformation comprises:
generating a first expression image based on the second facial keypoint image, wherein the first expression image is generated based on a connection of facial keypoints related to an expression in the second facial keypoint image; and
inputting the first expression image and the target image into the video generation model to obtain the first image corresponding to the target image that has undergone the facial expression transformation.

17. The method according to claim 16, wherein the video generation model comprises a first image encoder, a second image encoder, a diffusion model, and an image decoder, and inputting the first expression image and the first target image into the video generation model to obtain the first image corresponding to the target image that has undergone the facial expression transformation comprises:
inputting the first target image into the first image encoder to obtain a first image feature;
inputting the first expression image into the second image encoder to obtain a second image feature;
inputting the first image feature and the second image feature into the diffusion model to obtain a third image feature; and
obtaining, based on the third image feature, the first image corresponding to the target image that has undergone the facial expression transformation.

18. The method according to claim 17, wherein the diffusion model comprises an image generation module and a video synthesis module, and inputting the first image feature and the second image feature into the diffusion model to obtain the third image feature comprises:
inputting the first image feature and the second image feature into the image generation module to obtain a fourth image feature, wherein the fourth image feature is an image feature that is generated based on the target image and corresponding to the second image feature; and
inputting the fourth image feature into the video synthesis module to obtain the third image feature, wherein the video synthesis module is configured to achieve smoothness of a video during generation of the video based on a plurality of second image features.

19. The method according to claim 18, wherein adjusting the parameter value of the video generation model based on the first loss value comprises: adjusting parameter values of the second image encoder and the image generation module based on the first loss value.

20. The method according claim 18, further comprising:
obtaining a plurality of second expression images, a second target image comprising the face of the target object, and a plurality of second label images in one-to-one correspondence with the plurality of second expression images, wherein each of the plurality of second expression images is generated based on a connection of facial keypoints related to an expression in a corresponding facial keypoint image;
inputting the second target image into the first image encoder to obtain a fifth image feature;
inputting the plurality of second expression images into the second image encoder to obtain a plurality of sixth image features;
inputting the fifth image feature and the plurality of sixth image features into the image generation module to obtain a plurality of seventh image features, wherein the plurality of seventh image features are in one-to-one correspondence with the plurality of sixth image features;
inputting the plurality of seventh image features into the video synthesis module to obtain a plurality of eighth image features;
inputting the plurality of eighth image features into the image decoder to obtain a plurality of second images;
determining a second loss value by using the preset loss function based on the plurality of second images and the plurality of second label images; and
adjusting a parameter value of the video synthesis module based on the second loss value.

21. The method according to claim 12, wherein the preset loss function loss is determined based on the following formula:
$$loss = a \times ( C - \overline{C} ) + b \times ( D \times C - D \times \overline{C} )$$
wherein C̅ represents the first label image, C represents the first image, D represents a mouth mask image, and a and b are both preset hyperparameters.

22. An electronic device, comprising:
a memory storing one or more programs configured to be executed by one or more processors, the one or more programs including instructions for performing operations comprising:
obtaining a target image comprising a face of a target object;
performing facial keypoint extraction on the target image to obtain a first facial keypoint image;
obtaining, based on the first facial keypoint image and a preset set of expression bases, a first set of expression coefficients corresponding to the first facial keypoint image, wherein the first set of expression coefficients are in one-to-one correspondence with the set of expression bases;
adjusting a corresponding expression coefficient in the first set of expression coefficients to obtain a second set of expression coefficients corresponding to the target image that has undergone a facial expression transformation;
obtaining a second facial keypoint image based on the second set of expression coefficients and the preset set of expression bases; and
obtaining, based on the second facial keypoint image and the target image, a first image corresponding to the target image that has undergone the facial expression transformation.
